(19) United States
(12) Patent Application Publication
(10) Pub. No.: US 2022/0392253 A1
(43) Pub. Date: Dec. 8, 2022

(54) METHOD FOR PROCESSING IMAGES, ELECTRONIC DEVICE, AND STORAGE MEDIUM

(71) Applicant: BEIJING DAJIA INTERNET INFORMATION TECHNOLOGY CO., LTD., Beijing (CN)

(72) Inventor: Ying LIU, Beijing (CN)

(21) Appl. No.: 17/820,026

(22) Filed: Aug. 16, 2022

Related U.S. Application Data
(63) Continuation of application No. PCT/CN2020/132994, filed on Nov. 30, 2020.

(30) Foreign Application Priority Data
Mar. 23, 2020 (CN) 202010208723.6

(51) Int. Cl. G06V 40/16; G06T 7/70; G06T 7/20; G06V 10/74

(52) U.S. Cl. CPC G06V 40/161; G06T 7/70; G06T 7/20; G06V 10/761

(57) ABSTRACT

Provided is a method for processing images. The method includes: acquiring an initial morphed state of a target object in response to a change of an object recognition result for the target object in an image; acquiring a target morphed state of the target object; and displaying the target object progressively morphing from the initial morphed state to the target morphed state.

### CROSS-REFERENCE TO RELATED APPLICATION

This application is a continuation application of International Application No. PCT/CN2020/132994, filed on Nov. 30, 2020, which claims the priority of Chinese Application No. 202010208723.6, filed on Mar. 23, 2020, both of which are incorporated by reference herein.

### TECHNICAL FIELD

The present disclosure relates to the field of image processing technologies, and in particular, relates to a method for processing images, an electronic device and a storage medium.

### BACKGROUND

With the development of image processing technologies, an image morphing technology appears. The image morphing technology can morph a face, an arm or other target object included in an image to be processed, thereby optimizing the display of the target object in the image.

### SUMMARY

The present disclosure provides a method for processing images, an electronic device and a storage medium.

According to an aspect of embodiments of the present disclosure, a method for processing images is provided. The method is applicable to a terminal and includes: acquiring an initial morphed state of a target object in response to a change of an object recognition result for the target object in an image, wherein the initial morphed state is a last morphed state of the target object before the change, and the target object is an object subject to morphing; acquiring a target morphed state of the target object; and displaying the target object progressively morphing from the initial morphed state to the target morphed state.

According to another aspect of embodiments of the present disclosure, an electric device is provided. The electric device includes: one or more processors and one or more memories to store one or more instructions executable by the one or more processors. The one or more processors, when loading and executing the one or more instructions, are caused to: acquire an initial morphed state of a target object in response to a change of an object recognition result for the target object in an image, wherein the initial morphed state is a last morphed state of the target object before the change, and the target object is an object subject to morphing; acquire a target morphed state of the target object; and display the target object progressively morphing from the initial morphed state to the target morphed state.

According to still another aspect of embodiments of the present disclosure, a non-transitory computer-readable storage medium storing one or more instructions therein is provided. The one or more instructions, when loaded and executed by a processor of an electronic device, cause the electronic device to: acquire an initial morphed state of a target object in response to a change of an object recognition result for the target object in an image, wherein the initial morphed state is a last morphed state of the target object before the change, and the target object is an object subject to morphing; acquire a target morphed state of the target object; and display the target object progressively morphing from the initial morphed state to the target morphed state.

### BRIEF DESCRIPTION OF THE DRAWINGS

FIG. 1 is a diagram for an implementation environment of a method for processing images according to some embodiments of the present disclosure;

FIG. 2 is a flowchart of a method for processing images according to some embodiments of the present disclosure;

FIG. 3 is an effect diagram of a method for processing images according to some embodiments of the present disclosure;

FIG. 4 is a flowchart of a method for displaying a target object according to some embodiments of the present disclosure;

FIG. 5 is a flowchart of a method for acquiring a morphing magnitude according to some embodiments of the present disclosure;

FIG. 6 is a flowchart of a method for acquiring a morphing speed according to some embodiments of the present disclosure;

FIG. 7 is a flowchart of another method for processing images according to some embodiments of the present disclosure;

FIG. 8 is a block diagram of an apparatus for processing images according to some embodiments of the present disclosure; and

FIG. 9 is a diagram of an internal structure of an electronic device according to some embodiments of the present disclosure.

### DETAILED DESCRIPTION

For better understanding of technical solutions of the present disclosure by those of ordinary skill in the art, the technical solutions in embodiments of the present disclosure are described clearly and completely with reference to the accompanying drawings.

It should be noted that terms “first,” “second,” and the like in the description, claims and the accompanying drawings are intended to distinguish between similar objects instead of indicating a particular order or sequence. It should be understood that the data used in such a way are interchangeable under appropriate circumstances, such that embodiments of the present disclosure described herein can be implemented in an order other than the order illustrated or described herein. The embodiments and practice described in the following exemplary embodiments do not represent all embodiments and practice consistent with the present disclosure. On the contrary, they are merely examples of an apparatus and a method consistent with appended claims and aspects of the present disclosure.

The image morphing technology can morph a target object such as a face, or an arm in an image to optimize the display of the target object in the image. The morphing technology in related art relies too much on recognizing a key point of a target object. In a case that the key point is inaccurate or missing, a morphing effect of the target object is directly lost, such that an unprocessed image of the target object is directly displayed on a display interface. In a case that the target object reappears, the key point will be recognized, such that the target object will morph again. The final morphing effect is directly shown on the display interface again, thereby causing screen flickering.

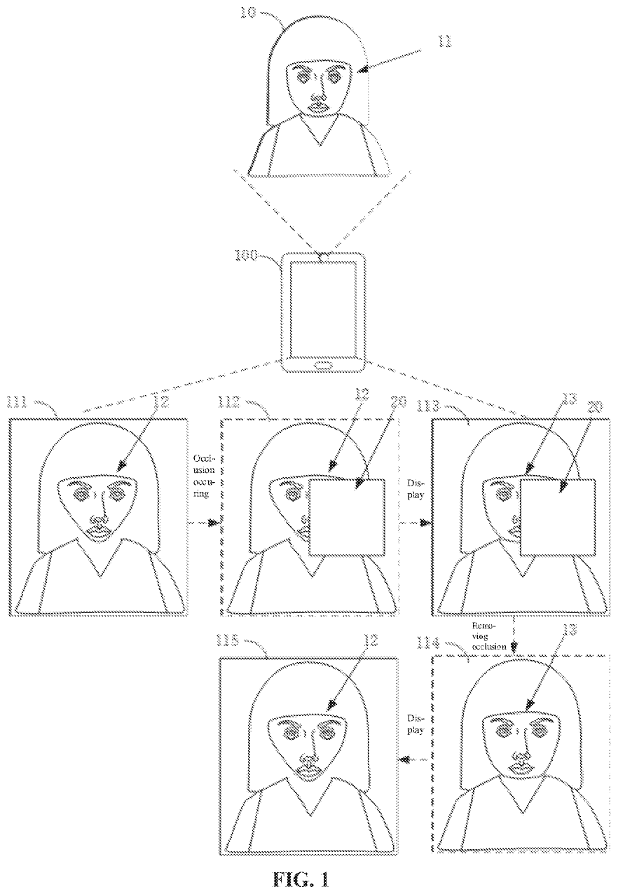

The method for processing images according to the present disclosure may be applied in an implementation environment as shown in FIG. 1. FIG. 1 is a diagram of an implementation environment of a method for processing images according to some embodiments of the present disclosure. The implementation environment may include a terminal 100. The terminal 100 may be, but is not limited to, a variety of personal computers, a laptop, a smartphone, a tablet and a portable wearable device.

Based on an image of a user 10 as captured by a camera provided thereon, the terminal 100 may morph a face 11 of the user 10. For example, based on the key point of the face in the captured image, an image corresponding to the face 11 of the user 10 may be slimed by liquefied morphing, thereby enabling the terminal 100 to display the image with the face being slimed on the display interface.

In some embodiments, the terminal 100 may capture the image of the user 10 in real time, take the face as the target object of morphing, and slim the face. The terminal 100 may display a first image 111 subjected to sliming, and the first image 111 may include a face 12 that has been slimed. That is, the target subject has been morphed in the first image 111. The terminal 100 may further display a second image 112, a third image 113, a fourth image 114 and a fifth image 115. The second image 112 is an image wherein an occlusion 20 appears. Referring to the second image 112, the occlusion 20 may occlude the target object (i.e., the face 12), such that the face recognizing model of the terminal 100 is unable to recognize the face 12. In this case, the face sliming effect according to the related art fails on the face 12, and the third image 113 is displayed directly on the display interface. The face 13 in the third image 113 is a face not subjected to sliming (that is, the face in the third image 113 or the target object in the third image 113 has not been morphed). Furthermore, in a case that the occlusion 20 is removed from the third image 113, as illustrated in the fourth image 114, the terminal 100 may re-recognize the face 13 in the fourth image 114. In this case, the face 13 is re-slimed according to the related art, and a fifth image 115 is directly displayed on the display interface. The face 12 in the fifth image 115 is a face subjected to sliming. Thus, in the related art, screen flickering may occur in the case that the target object such as a face is lost from the image or reappears in the image, and the beautifying effect of the target object is poor.

In the method for processing images according to the present disclosure, the terminal 100 may first determine whether the object recognition result for the target object in the image changes or not. In response to a change of the object recognition result for the target object in the image, an initial morphed state of the target object is acquired, the initial morphed state being a last morphed state of the target object before the change. That is, the last morphed state of the target object before the change is acquired as the initial morphed state of the target object. The terminal may further acquire a target morphed state of the target object. Then, the terminal 100 may display, on its display interface, the target object progressively morphing from the initial morphed state to the target morphed state. That is, the target object is displayed in a progressively morphing manner, wherein the initial morphed state and the target morphed state are respectively taken as the initial state and the final state of the progressively morphing process.

In some embodiments, in the method for processing images according to the present disclosure, the terminal 100 determines that the object recognition result changes in response to the face 12 in the second image 112 being occluded by an occlusion 20. That is, referring to the second image 112, the object recognition result changes from a face being recognized in the image to the face not being recognized in the image. Then, the terminal 100 may take a morphed state of the face 12 in the first image 111 before the change as the initial morphed state of the face 12, wherein the initial morphed state may be a final state of face sliming. And the terminal 100 may take an original state of the face 12 before the face sliming as the target morphed state. The target morphed state corresponds to the morphed state of the face 13 in the third image 113. In this case, the terminal 100 may display, on its display interface, the face in a progressively morphing manner, wherein the initial morphed state and the target morphed state are respectively taken as the initial state and the final state of the progressively morphing process. That is, the terminal 100 displays the progressively morphing process that the morphed state of the face 12 in the second image 112 progressively morphing to the morphed state of the face 13 in the third image 113.

In the case that the occlusion 20 in the third image 113 is removed, referring to the fourth image 114, the object recognition result acquired by the terminal 100 may change from the face not being recognized in the image to the face being recognized in the image. Then, the terminal 100 may take the morphed state of the face 13 in the third image 113 before the change as the initial morphed state of the face 13. The initial morphed state is the original state of the face before the face sliming. And the terminal 100 may further take the final state of the face sliming as the target morphed state. The target morphed state corresponds to the morphed state of the face 12 in the fifth image 115. In this case, the terminal 100 may display, on its display interface, the face in a progressively morphing manner, wherein the initial morphed state and the target morphed state are respectively taken as the initial state and the final state of the progressively morphing process. That is, the terminal 100 displays the progressively morphing process that the morphed state of the face 13 in the fourth image 114 progressively morphing to the morphed state of the face 12 in the fifth image 115. In this way, the screen flickering caused by sudden changes of the morphing effect due to the sudden appearance or loss of the target object such as the face in the image can be avoided, and the morphing effect of the target object can be optimized.

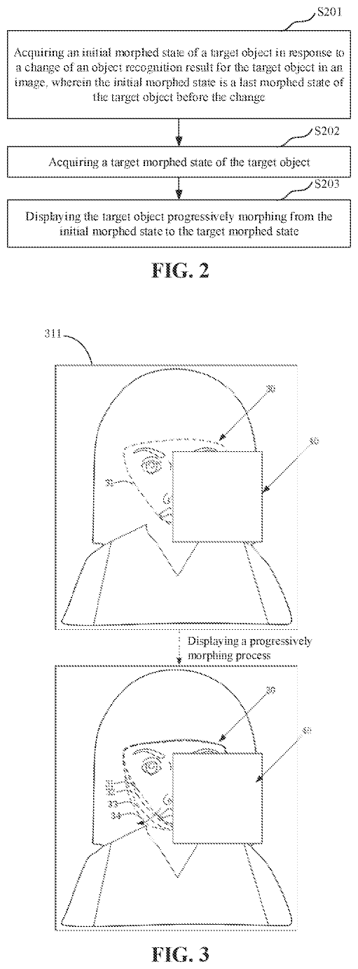

FIG. 2 is a flowchart of a method for processing images according to some embodiments of the present disclosure. As shown in FIG. 2, the method for processing images may be applicable to the terminal 100 shown in FIG. 1. The method includes S201 to S203.

In S201, an initial morphed state of a target object is acquired in response to a change of an object recognition result for the target object in an image, wherein the initial morphed state is a last morphed state of the target object before the change.

The target object herein is an object subject to morphing.

In other words, in response to the change of the object recognition result for the target object in the image, the last morphed state of the target object before the change is acquired as the initial morphed state of the target object.

In some embodiments, the terminal 100 may acquire each frame of the image and recognize the target object in the image while shooting a video or performing live streaming in real time. The target object in the image is the object subject to morphing. For example, the target object may be the face, arms, eyes, chin, and the like of the human being.

The terminal 100 acquires the initial morphed state of the target object in response to detecting the change of the object recognition result for the target object in the image. The initial morphed state may be an original state of the target object not subjected to morphing (i.e., the state of the target object that has not been morphed), or a final state of the target object subjected to morphing (i.e., the state of the target object that has been morphed), or an intermediate state between the original state and the final state. For example, in a case that the last morphed state of the target object before the change is the original state, the terminal 100 takes the original state as the initial morphed state of the target object. In a case that the last morphed state of the target object before the change is the final state, the terminal 100 takes the final state as the initial morphed state of the target object.

In some embodiments, the terminal 100 may determine whether the object recognition result changes or not. Firstly, the terminal 100 may acquire the object recognition result for the target object in the image in real time. The object recognition result may include the target object being recognized in the image or the target object not being recognized in the image. The terminal 100 may recognize the target object and acquire the object recognition result by using an object recognizing model. The object recognizing model herein may be a face recognizing model. The target object may be the face or the like in the image. The object recognition result may include the target object being recognized in the image or the target object not being recognized in the image. Secondly, the terminal 100 may determine that the object recognition result changes in response to the terminal 100 detecting that the object recognition result changing from the target object being recognized in the image to the target object not being recognized in the image or the object recognition result changing from the target object not being recognized in the image to the target object being recognized in the image.

In the case that the terminal 100 detects that the object recognition result changes from the target object being recognized in the image to the target object not being recognized in the image, it means that the terminal 100 could have successfully recognized the target object in the image but later fails to recognize the target object in the image due to factors such as occlusion, such that the terminal 100 determines that the object recognition result changes. Furthermore, in the case that the terminal 100 detects that the object recognition result changes from the target object not being recognized in the image to the target object being recognized in the image, it means that the terminal 100 could have failed to recognize the target object in the image possibly due to factors such as occlusion, but later successfully recognizes the target object in the image again possibly due to factors such as the removal of the occlusion, such that the terminal 100 may also determine that the object recognition result changes.

For example, in a case that the terminal 100 takes a face as a capture target, the terminal 100 may display the captured face on the screen in real time. The terminal 100 may track a position of the face in each frame and mark a key point of the face for beautifying process. In a case that a person moves relatively fast, or suddenly turns his/her head, or suddenly disappears from the screen, or the face of the person is occluded by an object, the corresponding frame image may lose the key point of the face. That is, the terminal 100 fails to recognize the key point of the face on the corresponding frame image, such that the acquired object recognition result is the face not being recognized in the image. In a case that the face reappears in the screen, the terminal 100 may successfully detect the face in the image again, such that the object recognition result acquired by the terminal 100 is the face being recognized in the image, such that the terminal 100 may determine that the object recognition result changes.

In S202, a target morphed state of the target object is acquired.

In some embodiments, the terminal 100 may acquire the target morphed state of the target object corresponding to the change. In a case that the morphed state of the target object before the change is the original state of the target object not subjected to morphing, the target morphed state corresponding to the change is the final state of the target object subjected to morphing. In a case that the morphed state of the target object before the change is the final state of the target object subjected to morphing, the target morphed state is the original state of the target object not subjected to morphing. In a case that the morphed state of the target object before the change is the intermediate state between the original state and the final state, a restored state corresponding to the intermediate state before the change may be taken as the target morphed state. For example, in a case that, before the change, the morphed state of the target object changes from the original state to the intermediate state, the restored state corresponding to the intermediate state before the change is the original state, and the original state is taken as the target morphed state. Similarly, in a case that, before the change, the morphed state of the target object changes from the final state to the intermediate state, the restored state corresponding to the intermediate state before the change is the final state, and the final state is taken as the target morphed state.

In S203, the target object progressively morphing from the initial morphed state to the target morphed state is displayed.

In some embodiments, the terminal 100 may display, on its display interface, the target object in a progressively morphing manner. The progressively morphing process has an initial state and a final state. After the initial morphed state and the target morphed state are required, the terminal 100 may display the target object progressively morphing from the initial morphed state to the target morphed state, wherein the initial morphed state is taken as the initial state of the progressively morphing process and the target morphed state is taken as the final state of the progressively morphing process.

FIG. 3 is an effect diagram of a method for processing images according to some embodiments of the present disclosure. The face 30 in the sixth image 311 is taken as the target object, and the face 30 is occluded by an occlusion 40. In this case, the terminal 100 displays the face 30 in a progressively morphing manner. It is assumed that an initial morphed state of the face 30 in the sixth image 311 is shown as the first morphed state 31, wherein the first morphed state 31 is a final state of the face 30 subjected to morphing. In a case that the face 30 under the first morphed state 31 is occluded by the occlusion 40, the terminal 100 may take a fourth morphed state 34 as the target morphed state, wherein the fourth morphed state 34 is an original state of the face 30 not subjected to morphing. A second morphed state 32 and a third morphed state 33 are two possible intermediate states between the initial state and the final state. When the terminal 100 displays the target object, the progressively morphing is implemented by progressively morphing the face 30 from the first morphed state 31 to the fourth morphed state 34 by undergoing the intermediate state, i.e., the second morphed state 32 and the third morphed state 33, and vice versa.

During the progressively morphing process, the occlusion 40 is removed, and the terminal 100 may restore the morphed state of the face 30. For example, the progressively morphing process is that the terminal 100 progressively morphs the face 30 from the first morphed state 31 to the fourth morphed state 34 by sequentially undergoing the second morphed state 32 and the third morphed state 33. Assuming that the occlusion 40 is removed when the face 30 is progressively morphing to the third morphed state 33, the terminal 100 may take a restored state corresponding to the third morphed state before the removal, i.e., the first morphed state 31, as the target morphed state, take the third morphed state 33 as the initial morphed state, and display the face 30 progressively morphing from the third morphed state 33 to the first morphed state 31. In this way, it is possible to progressively slim the face when the face is lost from the image and reappears in the image. In addition, the process may be controlled as a continuous process in which changes take place slowly, such that a user of the terminal 100 does not observe any obvious change. Thus, the screen flickering can be avoided by dynamically adapting the morphing effect based on dynamic changes of the target object such as the face in the image, and the screen flickering caused by the sudden changes of the morphing effect due to the sudden appearance or loss of the target object in the image can be avoided. Therefore, in a scenario where the face is morphing, it is possible to avoid the sudden change of morphing effect on the face when the face in the image is lost and reappears, thereby optimizing the morphing effect.

According to the aforesaid method for processing images, in the case that the terminal 100 detects that the object recognition result for the target object in the image changes, the terminal 100 may acquire the last morphed state of the target object before the change as the initial morphed state of the target object, and acquire the target morphed state of the target object corresponding to the change. The terminal 100 displays the target object in a progressively morphing manner, wherein the initial morphed state and the target morphed state are taken as the initial state and the final state of the progressively morphing process respectively.

In the solution according to the present disclosure, the target object may morph dynamically and adaptively based on dynamic change of the object recognition result. Based on the progressively morphing process that the target object progressively morphing from the initial morphed state to the target morphed state, the target object as displayed on the display interface of the terminal 100 may progressively morph from the initial morphed state to the target morphed state, such that the screen flickering caused by the sudden changes of the morphing effect due to the sudden appearance or loss of the target object in the image can be avoided, thereby optimizing the morphing effect of the target object.

In some embodiments, the target morphed state in S202 is a morphed state of the target object triggered by the change of the object recognition result, and the target morphed state is a second morphed state in the case that the object recognition result changes from a first object recognition result to a second object recognition result. In a case that the object recognition result changes from the target object being recognized to the target object not being recognized, the target morphed state is a state of the target object not subjected to morphing. In a case that the object recognition result changes from the target object not being recognized to the target object being recognized, the target morphed state is a state of the target object subjected to morphing. That is, in the case that the first object recognition result is the target object being recognized and the second object recognition result is the target object not being recognized, the second morphed state is the state of the target object not subjected to morphing. In the case that the first object recognition result is the target object not being recognized and the second object recognition result is the target object being recognized, the second morphed state is the state of the target object subjected to morphing.

The face being the target object is taken as an example. In the case that the face recognition result changes from the face being recognized to the face not being recognized, the target morphed state may be a state of no face sliming effect; and in the case that the face recognition result changes from the face not being recognized to the face being recognized, the target morphed state may be a state of the face sliming effect.

FIG. 4 is a flowchart of a method for displaying a target object according to some embodiments of the present disclosure. In S203, the initial morphed state and the target morphed state are respectively taken as the initial state and the final state of the progressively morphing process, and the target object is displayed in a progressively morphing manner. The process of S203 can be referred to S401 to S402.

In S401, a morphing magnitude of the target object is acquired based on the initial morphed state and the target morphed state.

The terminal 100 may determine the morphing magnitude of the target object based on the initial morphed state and the target morphed state, wherein the morphing magnitude refers to a magnitude of a change in morphed states of the target object.

In S402, the target object progressively morphing from the initial morphed state to the target morphed state at a morphing speed adapted to the morphing magnitude is displayed.

In other words, the terminal 100 may display the target object at a morphing speed adapted to the morphing magnitude.

In some embodiments, the terminal 100 may determine a suitable morphing speed based on the morphing magnitude. For example, the greater the morphing magnitude, the greater the morphing speed, and the smaller the morphing magnitude, the smaller the morphing speed. Optionally, the morphing magnitude is related to the initial morphed state and the target morphed state.

Two cases thereof will be analyzed in conjunction with FIG. 3. The first case is that the initial morphed state is the first morphed state 31 and the target morphed state is the fourth morphed state 34. The second case is that the initial morphed state is the third morphed state 33 and the target morphed state is the first morphed state 31. A morphing magnitude corresponding to the first case is greater than a morphing magnitude corresponding to the second case, because the target object in the first case has to morph from the final state to the original state with two intermediate states in between, whereas the target object in the second case only needs to morph from the intermediate state to the final state. The terminal 100 may set different morphing speeds for each of the two morphing magnitudes, wherein the morphing speed set in the first case is slightly faster than the morphing speed set in the second case. Thus, in the case that the target object is in different initial morphed states, the corresponding morphing speed, at which the progressively morphing process of the target object is displayed, can be flexibly adapted based on the corresponding morphing magnitude.

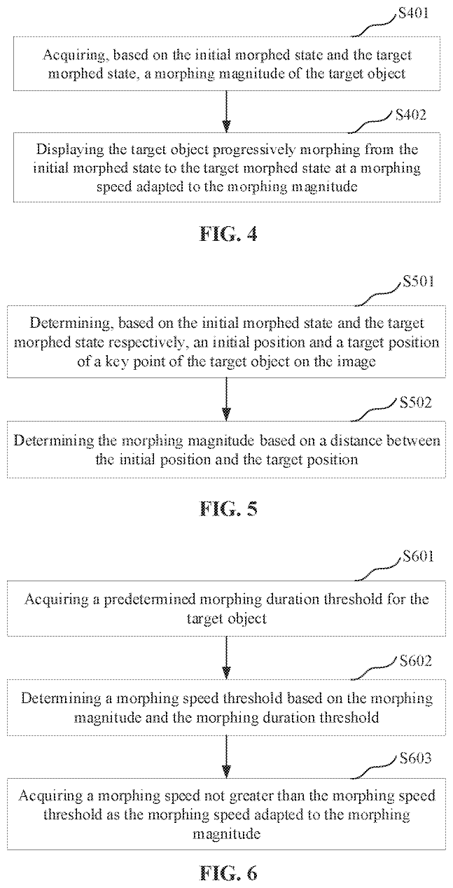

In some embodiments, FIG. 5 is a flowchart of a method for acquiring a morphing magnitude according to some embodiments of the present disclosure. The process of acquiring a morphing magnitude of the target object based on the initial morphed state and the target morphed state in S401 may include S501 to S502.

In 501, an initial position and a target position of a key point of the target object on the image are determined based on the initial morphed state and the target morphed state respectively.

The key point is a pixel point of the image for morphing the target object. In a specific application scenario, the terminal 100 may recognize and mark the key point of the target object such as the face on the image, and morph, based on the key point, the target object by liquefied morphing, thereby morphing or beautifying the face. At least one key point of the target object is present on the image.

In some embodiments, the terminal 100 may determine the initial position of the key point of the target object on the image based on the initial morphed state of the target object, and determine the target position of the key point of the target object on the image based on the target morphed state of the target object.

In S502, the morphing magnitude is determined based on a distance between the initial position and the target position.

In some embodiments, the terminal 100 may take the distance between the initial position and the target position of the key point of the target object on the image as the morphing magnitude of the target object. In a case where the greater the distance between the initial position and the target position, the greater the morphing magnitude of the target object, the terminal 100 may morph the target object with a relatively great magnitude. In a case where the smaller the distance between the initial position and the target position, the smaller the morphing magnitude of the target object, the terminal 100 may morph the target object with a relatively small magnitude.

Thus, in the solution according to the embodiments of the present disclosure, the morphing magnitude of the target object can be determined accurately and efficiently, thereby optimizing the morphing effect of the target object.

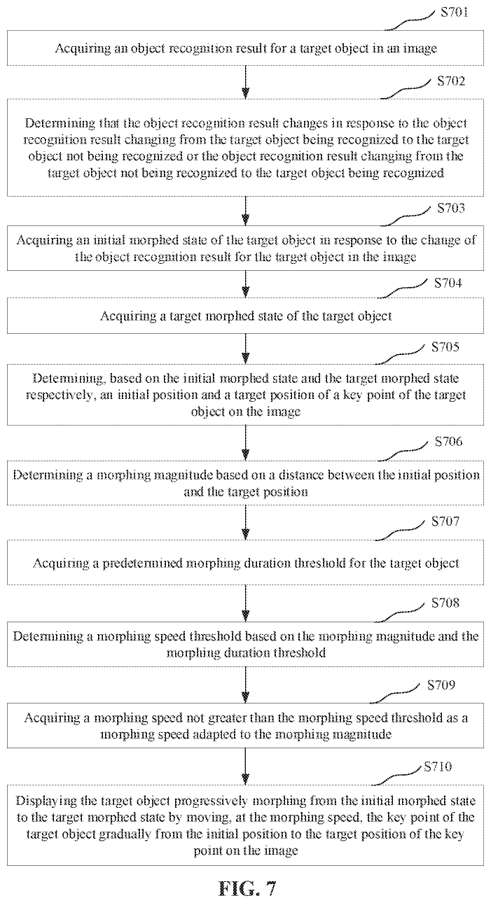

In some embodiments, FIG. 6 is a flowchart of a method for acquiring a morphing speed according to some embodiments of the present disclosure. Prior to the process of displaying the target object at a morphing speed adapted to the morphing magnitude in S402, the method may further include S601 to S603.

In S601, a predetermined morphing duration threshold for the target object is acquired.

In S602, a morphing speed threshold is determined based on the morphing magnitude and the predetermined morphing duration threshold.

In S603, a morphing speed not greater than the morphing speed threshold is acquired as the morphing speed adapted to the morphing magnitude.

In some embodiments, the terminal 100 may acquire a predetermined morphing duration threshold for the target object. The morphing duration threshold may be a maximum duration of the progressively morphing process of the target object. The morphing duration threshold may be used to limit the morphing speed of the target object, such that the progressively morphing process of the target object is relatively continuous and the target object morphs slowly and slightly. In some embodiments, the morphing speed threshold may be predetermined as 2 seconds. The terminal 100 may then acquire a morphing speed threshold based on the morphing magnitude and the morphing duration threshold. For example, the terminal 100 may take a ratio of the morphing magnitude to the morphing duration threshold as the morphing speed threshold. In some embodiments, the morphing magnitude may be the distance between the initial position and the target position of the key point of the target object on the image, and a ratio of the distance to the morphing speed threshold is taken as the morphing speed threshold.

After the morphing speed threshold is acquired, the terminal 100 may acquire a suitable morphing speed based on the morphing speed threshold. In the embodiments of the present disclosure, the terminal 100 may take a morphing speed not greater than the morphing speed threshold as the morphing speed adapted to the morphing magnitude, such that the target object can progressively morph from the initial morphed state to the target morphed state at a low speed. Further, in some embodiments, the morphing speed may be a constant value not greater than the morphing speed threshold. The target object progressively morphs from the initial morphed state to the target morphed state at a uniform speed, such that the progressively morphing process is more continuous and slighter. To facilitate the acquisition of the morphing speed, the terminal 100 may directly take the morphing speed threshold as the morphing speed. In some embodiments, the morphing speed may be a progressively changing value not greater than the morphing speed threshold. The morphing speed may be progressively greater or smaller or may get greater and then smaller or get smaller and then greater.

In some embodiments, the process of displaying the target object progressively morphing from the initial morphed state to the target morphed state at the morphing speed adapted to the morphing magnitude in S402 may include: displaying the target object progressively morphing from the initial morphed state to the target morphed state by moving, at the morphing speed, the key point of the target object gradually from the initial position to the target position of the key point on the image. The initial position of the key point on the image is acquired based on the initial morphed state and the target position of the key point on the image is acquired based on the target morphed state.

In the embodiments of the present disclosure, the terminal 100 implements the progressively morphing process that the target object progressively morphing from the initial state to the final state by moving the position of the key point of the target object on the image. The positions of the key point of the target object on the image includes the initial position and the target position, wherein the two positions may be respectively acquired based on the initial morphed state and the target morphed state. The initial position may be acquired based on the initial morphed state, and the target position may be acquired based on the target morphed state.

In the solution according to the embodiments of the present disclosure, based on the distance between the initial position and the target position of the key point of the target object on the image, a suitable morphing speed may be determined for the key point of the target object gradually moving from the initial position to the target position on the image. The terminal 100 may acquire the predetermined morphing duration threshold of the target object, take the ratio of the distance to the morphing duration threshold as the morphing speed, and gradually move the key point of the target object from the initial position to the target position on the image at the morphing speed, thereby achieving the target object progressively morphing from the initial state to the final state.

FIG. 7 is a flowchart of another method for processing images according to some embodiments of the present disclosure. The method for processing images may be performed by the terminal 100 shown in FIG. 1 or the similar devices. The method includes S701 to S710.

In S701, the terminal 100 acquires an object recognition result for a target object in an image.

In some embodiments, the target object in the image refers to the object subject to morphing. The object recognition result includes: the target object being recognized in the image or the target object not being recognized in the image.

In S702, the terminal 100 determines that the object recognition result changes in response to the object recognition result changing from the target object being recognized to the target object not being recognized or the object recognition result changing from the target object not being recognized to the target object being recognized.

In S703, the terminal 100 acquires an initial morphed state of the target object in response to the change of the object recognition result for the target object in the image.

That is, the terminal acquires the last morphed state of the target object before the change as the initial morphed state of the target object.

In S704, the terminal 100 acquires a target morphed state of the target object.

In S705, the terminal determines, based on the initial morphed state and the target morphed state respectively, an initial position and a target position of a key point of the target object on the image.

In some embodiments, the key point is a pixel point on the image for morphing the target object.

In S706, the terminal 100 determines a morphing magnitude based on a distance between the initial position and the target position.

The terminal may take the distance between the initial position and the target position as the morphing magnitude.

In S707, the terminal 100 acquires a predetermined morphing duration threshold for the target object.

In S708, the terminal 100 determines a morphing speed threshold based on the morphing magnitude and the predetermined morphing duration threshold.

The terminal 100 may take a ratio of the morphing magnitude to the morphing duration threshold as the morphing speed threshold.

In S709, the terminal 100 acquires a morphing speed not greater than the morphing speed threshold as a morphing speed adapted to the morphing magnitude.

The terminal 100 may take the morphing speed threshold as the morphing speed.

In S710, the terminal 100 displays the target object progressively morphing from the initial morphed state to the target morphed state by moving, at the morphing speed, the key point of the target object gradually from the initial position to the target position of the key point on the image.

In the method for processing images, based on the key point of the target object, the target object may morph dynamically and adaptively according to the dynamic changes of the object recognition result, thereby optimizing the morphing effect of the target object.

To illustrate the method for processing images according to the present disclosure more clearly, the method is described by being applied for beautifying the face of the image.

In general, while shooting a video or performing live streaming in real time via the terminal 100, the terminal 100 may acquire each frame of the image, recognize and mark the key point of the face in the image, and liquefy and beautify the face based on the key point to achieve a face sliming effect and/or other beautifying effects. When a person moves relatively fast, or suddenly turns his/her head, or suddenly lost and reappears in the screen, or the face is occluded by an object, the corresponding frame image lose the key point of the face. Thus, if the image is processed in the conventional fashion, the sliming effect on the face may fail, and the face may be suddenly slimed when the face reappears in the image, such that the moment when the face is morphing may be recorded in the video. In this case, a viewer in the live streaming room may directly see the sudden change on the face, and the beautifying effect of the face is rather poor, which affects the user experience.

In the method for processing images according to the present disclosure, the face in the image can be beautified. In some embodiments, firstly, when a face is present on the image, the position of the face in each frame may be traced by the face recognizing and tracking technique, thereby marking the key point of the face for beautifying.

Secondly, when the face is lost, the position of the key point of the face in the last frame may be recorded, and the face sliming effect in the last frame may be kept for subsequently gradually morphing process. The initial point of the progressively morphing process is defined as the face-sliming effect of the last frame of the face, and the final point of the progressively morphing process is defined as the original state of the face, i.e., the state when the face-sliming effect is completely removed. Then, a 2-second progressively morphing process for recovery may be configured at a constant speed from the initial point to the final point, and the progressively morphing effect is implemented by moving pixels from the key point of the face at the initial point to the key point of the face at the final point. The 2 seconds are a predetermined maximum duration for progressively morphing from the final face sliming effect to the original state of the face, which may be determined according to the actual needs in scenarios. Thus, an average speed of the progressively morphing process for the face may be acquired as v. The value of the average speed is a ratio of the predetermined maximum duration of 2 seconds to the morphing magnitude of the key point of the face. That is, the value of the average speed is a ratio of the predetermined maximum duration of 2 seconds to the distance between the pixels of the key point of the face. Because the key point of the face changes slowly from the initial point to the final point, a user generally cannot observe the change. In addition, the face may reappear within this duration, and the face sliming may be implemented again. Thus, the flickering may not occur even if the face suddenly reappears or disappears in actual shooting.

Finally, when the key point of the face is detected again, the initial point is defined as the current state of the face. The state may refer to a face with no face sliming effect or an intermediate state where the face sliming effect slowly disappears. Then, the current position of the key point of the face is acquired, and the final point is defined as the final state of the face sliming. The final state may be acquired by calculating the sliming effect based on the current state of the face and the positions of the key point. A uniform progressively morphing process with speed v may be performed from the initial point to the final point.

As a result, the user may start a progressively face sliming process from the time the face is lost to the time the face reappears, which is a continuous process with slow morphing, and a process the morphing of which can hardly be observed by the user. Thus, based on the beautifying logic with the progressively morphing process, error displays as caused by the presence or absence of the key point of the face can be avoided.

It shall be understood that although the individual processes in the flowcharts of FIG. 2 and FIG. 4 to FIG. 7 are shown sequentially as indicated by arrows, the processes are not necessarily performed sequentially in the order indicated by the arrows. Unless explicitly stated herein, these processes are performed in no strict order and they can be performed in any other order. At least some of the processes in FIG. 2 and FIG. 4 to FIG. 7 may include a plurality of processes or stages. These processes or stages are not necessarily completed at the same moment, but may be performed at different moments. In addition, the order in which these processes or stages are performed is not necessarily sequential, but may be performed alternately or alternatively with other processes or at least some of the processes or stages of other processes.

FIG. 8 is a block diagram of an apparatus for processing images according to some embodiments of the present disclosure. Referring to FIG. 8, the apparatus for processing images 800 includes an initial state acquiring module 801, a target state acquiring module 802, and an object displaying module 803.

The initial state acquiring module 801 is configured to acquire an initial morphed state of a target object in response to a change of an object recognition result for the target object in an image. The initial morphed state is a last morphed state of the target object before the change, and the target object is an object subject to morphing.

The target state acquiring module 802 is configured to acquire a target morphed state of the target object.

The object displaying module 803 is configured to display the target object progressively morphing from the initial morphed state to the target morphed state.

In some embodiments, the object displaying module 803 includes a magnitude acquiring unit and an object displaying unit.

The magnitude acquiring unit is configured to determine, based on the initial morphed state and the target morphed state, a morphing magnitude of the target object, wherein the morphing magnitude is a magnitude of a change in morphed states of the target object.

The object displaying unit is configured to display the target object progressively morphing from the initial morphed state to the target morphed state at a morphing speed adapted to the morphing magnitude.

In some embodiments, the magnitude acquiring module is configured to determine, based on the initial morphed state and the target morphed state respectively, an initial position and a target position of a key point of the target object on the image, and determine the morphing magnitude based on a distance between the initial position and the target position. The key point is a pixel point of the image for morphing the target object.

In some embodiments, the object displaying unit is further configured to acquire a predetermined morphing duration threshold for the target object, determine a morphing speed threshold based on the morphing magnitude and the morphing duration threshold, and acquire the morphing speed, wherein the morphing speed is not greater than the morphing speed threshold.

In some embodiments, the morphing speed is a constant value not greater than the morphing speed threshold.

In some embodiments, the object displaying unit is configured to display the target object progressively morphing from the initial morphed state to the target morphed state by moving, at the morphing speed, the key point of the target object gradually from the initial position to the target position of the key point on the image. The initial position of the key point on the image is acquired based on the initial morphed state and the target position of the key point on the image is acquired based on the target morphed state.

In some embodiments, the apparatus for processing images 800 further includes a result acquiring module and a change determining module.

The result acquiring module is configured to acquire an object recognition result for the target object in the image, wherein the object recognition result includes the target object being recognized in the image or the target object not being recognized in the image.

The change determining module is configured to determine that the object recognition result changes in response to the object recognition result changing from the target object being recognized to the target object not being recognized or the object recognition result changing from the target object not being recognized to the target object being recognized.

In some embodiments, the target morphed state is a morphed state of the target object triggered by the change of the object recognition result.

In some embodiments, the target morphed state is a state of the target object not subjected to morphing, in a case that the object recognition result changes from the target object being recognized to the target object not being recognized; and the target morphed state is a state of the target object subjected to morphing, in a case that the object recognition result changes from the target object not being recognized to the target object being recognized.

With regard to the apparatus in the forgoing described embodiments, the specific manner in which the respective modules perform the operations has been described in detail in the method embodiments, and will not be explained in detail herein.

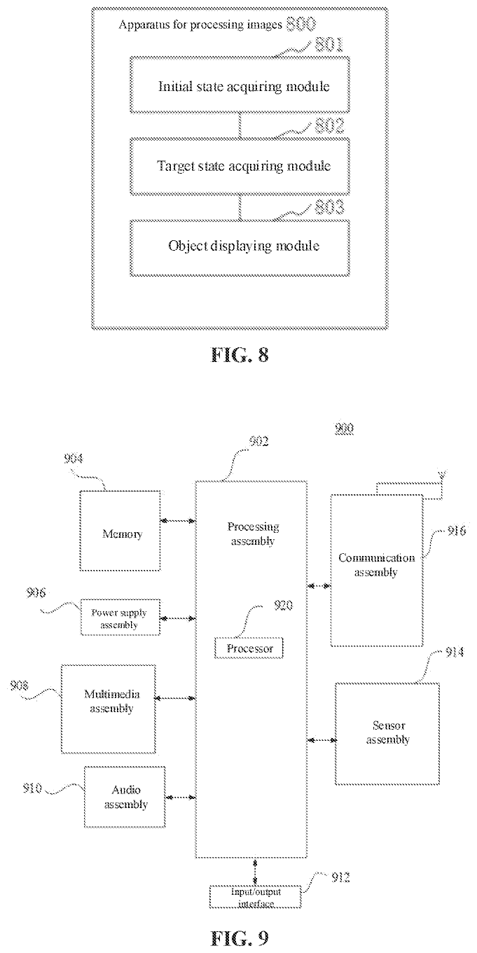

FIG. 9 is a diagram of an internal structure of an electronic device according to some embodiments of the present disclosure. For example, the electronic device 900 may be a cell phone, a computer, a digital broadcast terminal, a message sending and receiving device, a game console, a tablet device, a medical device, a fitness device, a personal digital assistant, and the like.

Referring to FIG. 9, the electronic device 900 may include one or more of: processing assembly 902, memory 904, power assembly 906, multimedia assembly 908, audio assembly 910, input/output (I/O) interface 912, sensor assembly 914, and communication assembly 916.

The processing assembly 902 typically controls overall operations of the electronic device 900, such as operations associated with display, telephone call, data communication, camera operation, and recording operations. The processing assembly 902 may include one or more processors 920 to load execute one or more instructions to perform all or some of the processes of the method described above. In addition, the processing assembly 902 may include one or more modules to facilitate interaction between the processing assembly 902 and other assemblies. For example, the processing assembly 902 may include a multimedia module to facilitate interaction between the multimedia assembly 908 and the processing assembly 902.

The memory 904 is configured to store various types of data to support operations at the electronic device 900. Examples of such data include one or more instructions for any application or method of operation on the electronic device 900, contact data, phonebook data, messages, pictures, videos, and the like. The memory 904 may be implemented by any type of volatile or non-volatile storage device, or a combination thereof, such as a static random-access memory (SRAM), an electrically-erasable programmable read-only memory (EEPROM), an erasable programmable read-only memory (EPROM), a programmable read only memory (PROM), a read only memory (ROM), a magnetic memory, a flash memory, a disk or a CD.

The power assembly 906 provides power to various assemblies of the electronic device 900. The power assembly 906 may include a power management system, one or more power supplies, and other assemblies associated with generating, managing, and distributing power for the electronic device 900.

The multimedia assembly 908 includes a screen that provides an output interface between the electronic device 900 and the user. In some embodiments, the screen may include a liquid crystal display (LCD) and a touch panel (TP). In the case that the screen includes the TP, the screen may be implemented as a touch screen to receive input signals from the user. The TP includes one or more touch sensors to sense touches, swipes, and gestures on the touch panel. The touch sensor may not only sense the boundary of the touch or swipe actions, but also detect the duration and pressure associated with the touch or swipe actions. In some embodiments, the multimedia assembly 908 includes a front-facing camera and/or a rear-facing camera. The front-facing camera and/or the rear-facing camera may receive the external multimedia data when the electronic device 900 is in an operating mode, such as shooting mode or video mode. Each front-facing camera and each rear-facing camera may be a fixed optical lens system or have focal length and optical zoom capability.

The audio assembly 910 is configured to output and/or input an audio signal. For example, the audio assembly 910 includes a microphone (MIC). The microphone is configured to receive an external audio signal when the electronic device 900 is in an operating mode, such as call mode, record mode, and voice recognizing mode. The received audio signal may be further stored in the memory 904 or sent via the communication assembly 916. In some embodiments, the audio assembly 910 further includes a speaker for outputting the audio signal.

The I/O interface 912 provides an interface between the processing assembly 902 and a peripheral interface module. The peripheral interface module may be a keyboard, a click wheel, a button, and the like. These buttons may include, but are not limited to a home button, a volume button, a start button, and a lock button.

The sensor assembly 914 includes one or more sensors for providing status assessment of various aspects of the electronic device 900. For example, the sensor assembly 914 may detect an open/closed state of the electronic device 900 and the relative positioning of assemblies, such as the assemblies being the display and keypad of the electronic device 900. The sensor assembly 914 may also detect a change of the position of the electronic device 900 or an assembly of the electronic device 900, the presence or absence of user contact with the electronic device 900, the orientation or acceleration/deceleration of the electronic device 900 and a change of temperature of the electronic device 900. The sensor assembly 914 may include a proximity sensor configured to detect the presence of a nearby object without any physical contact. The sensor assembly 914 may further include a light sensor, such as a complementary metal-oxide semiconductor (CMOS) or a charge coupled device (CCD) image sensor. The light sensor is used for imaging applications. In some embodiments, the sensor assembly 914 may further include an accelerometer sensor, a gyroscope sensor, a magnetic sensor, a force sensor, or a temperature sensor.

The communication assembly 916 is configured to facilitate communication between the electronic device 900 and other devices by wired or wireless means. The electronic device 900 may access a wireless network based on a communication standard, such as wireless-fidelity (Wi-Fi), a carrier network (e.g., 2G, 3G, 4G, or 5G), or a combination thereof. In some embodiments, the communication assembly 916 receives broadcast signals or broadcast-related information from an external broadcast management system via a broadcast channel. In some embodiments, the communication assembly 916 further includes a near field communication (NFC) module to facilitate short-range communication. For example, the NFC module may be implemented based on the radio frequency identification (RFID) technology, infrared data association (IrDA) technology, ultra wide band (UWB) technology, Bluetooth (BT) technology and other technologies.

In some embodiments, the electronic device 900 may be implemented by one or more application specific integrated circuits (ASIC), digital signal processors (DSP), digital signal processing devices (DSPD), programmable logic devices (PLD), field-programmable gate arrays (FPGA), controllers, microcontrollers, microprocessors, or other electronic components. The electronic device 900 is configured to:

acquire an initial morphed state of a target object in response to a change of an object recognition result for the target object in an image, wherein the initial morphed state is a last morphed state of the target object before the change, and the target object is an object subject to morphing;

acquire a target morphed state of the target object; and

display the target object progressively morphing from the initial morphed state to the target morphed state.

In some embodiments, a non-transitory computer readable storage medium storing one or more instructions therein is further provided. For example, the non-transitory computer readable storage medium is the memory 904 storing one or more instructions. The one or more instructions, when loaded and executed by a processor 920 of the electronic device 900, cause the electronic device 900 to:

acquire an initial morphed state of a target object in response to a change of an object recognition result for the target object in an image, wherein the initial morphed state is a last morphed state of the target object before the change, and the target object is an object subject to morphing;

acquire a target morphed state of the target object; and

display the target object that progressively morphing from the initial morphed state to the target morphed state.

In some embodiments, the one or more instructions, when loaded and executed by the processor 920 of the electronic device 900, cause the electronic device 900 to: determine, based on the initial morphed state and the target morphed state, a morphing magnitude of the target object, wherein the morphing magnitude is a magnitude of a change in morphed states of the target object; and display the target object progressively morphing from the initial morphed state to the target morphed state at a morphing speed adapted to the morphing magnitude.

For example, the non-transitory computer readable storage medium may be a ROM, a random access memory (RAM), a compact disk read only memory (CD-ROM), a magnetic tape, a floppy disk, an optical data storage device or the like.

In some embodiments, a computer program product including a computer program is further provided. The computer program is stored in a non-transitory computer-readable storage medium. The computer program, when read from the non-transitory computer-readable storage medium and running by at least one processor of a device, causes the device to:

acquire an initial morphed state of a target object in response to a change of an object recognition result for the target object in an image, wherein the initial morphed state is a last morphed state of the target object before the change, and the target object is an object subject to morphing;

acquire a target morphed state of the target object; and

display the target object progressively morphing from the initial morphed state to the target morphed state.

All the embodiments of the present disclosure can be implemented independently or in combination with other embodiments, which are all regarded as falling within the protection scope of the present disclosure.

What is claimed is:

1. A method for processing images, applicable to an electronic device, the method comprising:
acquiring an initial morphed state of a target object in response to a change of an object recognition result for the target object in an image, wherein the initial morphed state is a last morphed state of the target object before the change, and the target object is an object subject to morphing;
acquiring a target morphed state of the target object; and
displaying the target object progressively morphing from the initial morphed state to the target morphed state.

2. The method according to claim 1, wherein said displaying the target object progressively morphing from the initial morphed state to the target morphed state comprises:
determining, based on the initial morphed state and the target morphed state, a morphing magnitude of the target object, wherein the morphing magnitude is a magnitude of a change in morphed states of the target object; and
displaying the target object progressively morphing from the initial morphed state to the target morphed state at a morphing speed adapted to the morphing magnitude.

3. The method according to claim 2, wherein said determining, based on the initial morphed state and the target morphed state, the morphing magnitude of the target object comprises:
determining, based on the initial morphed state and the target morphed state respectively, an initial position and a target position of a key point of the target object on the image, wherein the key point is a pixel point of the image for morphing the target object; and
determining the morphing magnitude based on a distance between the initial position and the target position.

4. The method according to claim 2, further comprising:
acquiring a predetermined morphing duration threshold for the target object;
determining a morphing speed threshold based on the morphing magnitude and the predetermined morphing duration threshold; and
acquiring the morphing speed, wherein the morphing speed is not greater than the morphing speed threshold.

5. The method according to claim 4, wherein the morphing speed is a constant value not greater than the morphing speed threshold.

6. The method according to claim 2, wherein said displaying the target object progressively morphing from the initial morphed state to the target morphed state at the morphing speed adapted to the morphing magnitude comprises:
displaying the target object progressively morphing from the initial morphed state to the target morphed state by moving, at the morphing speed, the key point of the target object gradually from the initial position to a target position of the key point on the image;
wherein the initial position of the key point on the image is acquired based on the initial morphed state, and the target position of the key point on the image is acquired based on the target morphed state.

7. The method according to claim 1, further comprising:
acquiring an object recognition result for the target object in the image, wherein the object recognition result comprises the target object being recognized in the image or the target object not being recognized in the image; and
determining that the object recognition result changes in response to the object recognition result changing from the target object being recognized to the target object not being recognized or the object recognition result changing from the target object not being recognized to the target object being recognized.

8. The method according to claim 1, wherein the target morphed state is a morphed state of the target object triggered by the change of the object recognition result, and is a second morphed state in the case that the object recognition result changes from a first object recognition result to a second object recognition result.

9. The method according to claim 1, wherein the target morphed state is a morphed state of the target object triggered by the change of the object recognition result,
the target morphed state is a state of the target object not subjected to morphing, in the case that the object recognition result changes from the target object being recognized to the target object not being recognized; and
the target morphed state is a state of the target object subjected to morphing, in the case that the object recognition result changes from the target object not being recognized to the target object being recognized.

10. An electronic device, comprising:
one or more processors;
one or more memories configured to store one or more instructions executable by the one or more processors;
wherein the one or more processors, when loading and executing the one or more instructions, are caused to:
acquire an initial morphed state of a target object in response to a change of an object recognition result for the target object in an image, wherein the initial morphed state is a last morphed state of the target object before the change, and the target object is an object subject to morphing;
acquire a target morphed state of the target object; and
display the target object progressively morphing from the initial morphed state to the target morphed state.

11. The electronic device according to claim 10, wherein the one or more processors, when loading and executing the one or more instructions, are caused to:
determine, based on the initial morphed state and the target morphed state, a morphing magnitude of the target object, wherein the morphing magnitude is a magnitude of a change in morphed states of the target object; and
display the target object progressively morphing from the initial morphed state to the target morphed state at a morphing speed adapted to the morphing magnitude.

12. The electronic device according to claim 11, wherein the one or more processors, when loading and executing the one or more instructions, are caused to:
determine, based on the initial morphed state and the target morphed state respectively, an initial position and a target position of a key point of the target object on the image, wherein the key point is a pixel point of the image for morphing the target object; and
determine the morphing magnitude based on a distance between the initial position and the target position.

13. The electronic device according to claim 11, wherein the one or more processors, when loading and executing the one or more instructions, are caused to:
acquire a predetermined morphing duration threshold for the target object;
determine a morphing speed threshold based on the morphing magnitude and the predetermined morphing duration threshold; and
acquire the morphing speed, wherein the morphing speed is not greater than the morphing speed threshold.

14. The electronic device according to claim 13, wherein the morphing speed is a constant value not greater than the morphing speed threshold.

15. The electronic device according to claim 11, wherein the one or more processors, when loading and executing the one or more instructions, are caused to:
display the target object progressively morphing from the initial morphed state to the target morphed state by moving, at the morphing speed, the key point of the target object gradually from the initial position to a target position of the key point on the image;
wherein the initial position of the key point on the image is acquired based on the initial morphed state and the target position of the key point on the image is acquired based on the target morphed state.

16. The electronic device according to claim 10, wherein the one or more processors, when loading and executing the one or more instructions, are further caused to:
acquire an object recognition result for the target object in the image, wherein the object recognition result comprises the target object being recognized in the image or the target object not being recognized in the image; and
determine that the object recognition result changes in response to the object recognition result changing from the target object being recognized to the target object not being recognized or the object recognition result changing from the target object not being recognized to the target object being recognized.

17. The electronic device according to claim 10, wherein the target morphed state is a morphed state of the target object triggered by the change of the object recognition result, and is a second morphed state in the case that the object recognition result changes from a first object recognition result to a second object recognition result.

18. The electronic device according to claim 10, wherein the target morphed state is a morphed state of the target object triggered by the change of the object recognition result, the target morphed state is a state of the target object not subjected to morphing in the case that the object recognition result changes from the target object being recognized to the target object not being recognized; and the target morphed state is a state of the target object subjected to morphing, in the case that the object recognition result changes from the target object not being recognized to the target object being recognized.

19. A non-transitory computer-readable storage medium storing one or more instructions therein, wherein the one or more instructions, when loaded and executed by a processor of an electronic device, cause the electronic device to:
acquire an initial morphed state of a target object in response to a change of an object recognition result for the target object in an image, wherein the initial morphed state is a last morphed state of the target object before the change, and the target object is an object subject to morphing;
acquire a target morphed state of the target object; and
display the target object progressively morphing from the initial morphed state to the target morphed state.

20. The non-transitory computer-readable storage medium according to claim 19, wherein the one or more instructions, when loaded and executed by the processor of the electronic device, cause the electronic device to:
determine, based on the initial morphed state and the target morphed state, a morphing magnitude of the target object, wherein the morphing magnitude is a magnitude of a change in morphed states of the target object; and
display the target object progressively morphing from the initial morphed state to the target morphed state at a morphing speed adapted to the morphing magnitude.
